(19) United States
(12) Patent Application Publication
(10) Pub. No.: US 2020/0359602 A1
(43) Pub. Date: Nov. 19, 2020

(54) Harness

(71) Applicant: Sae Jung Oh, Seattle, WA (US)

(72) Inventor: Sae Jung Oh, Seattle, WA (US)

(21) Appl. No.: 16/414,119

(22) Filed: May 16, 2019

(51) Int. Cl. A01K 27/00

(52) U.S. Cl. CPC A01K 27/002; A01K 27/001; A01K 27/003

(57) ABSTRACT

A harness may include harness straps, a leash and harness straps connection component, a chest component, and an end of leash component, which work to supply flexibility in sizing. The harness system may adjust the size and fit of the harness on a dog to readily adapt to a growing dog and reduce the need to buy new harnesses.

### FIELD

This disclosure generally relates to a harness.

### BACKGROUND

A harness is a mechanism used for control or support, among other things. It is now common to use harnesses to control dogs, other animals, or objects. Harnesses allow leashes to attach to a dog without putting stress on the dog's delicate neck like a traditional collar and leash system. The harnesses tend to attach around each of the animals' front legs. This allows the animal to be secure and therefore easier to safety guide and control. While many brands sell dog harnesses in a variety of sizes, shapes, colors, and materials, it can be difficult to find an exact fit and the harnesses are minimally adjustable. As dogs grow, there is often a need to purchase replacement harnesses.

### SUMMARY

The instant application presents a simplified summary of the disclosure to provide a brief overview to the reader in which to present key concepts. A more detailed description of the disclosure can be found in subsequent sections of this application.

The instant application discloses, among other things, a harness. While this disclosure uses dog harnesses as examples, a harness makes it adaptable for use with other animals, people, or objects. The harness may be made primarily of a cord, such as a rope, which is configured so that part of it forms two straps which go around the front legs of the dog and another part forms a leash. The cord may be adjustable by slipping through an adjustable component, such as a piece of leather having holes that may hold the cord snugly in place via friction. The cord may be made from a durable material that has sufficient tensile strength to withstand the tension put on it by users. The length of the straps may be adjusted at an interconnection, which may be made of soft leather or another strong material, that encloses and connects the end of the straps and allows the remainder of the harness to be used as a leash.

The straps may pass through a chest point; a connector near a mid-point of the straps, which may be under a dog's chest. The connector may be made from a sturdy but soft material such as leather, so that it is comfortable to the dog and may withstand any tension exerted on it during use. This connector may ensure that the straps do not rest in a dog's armpit area and apply dangerous stress to the dog's arm joint. The straps may connect through a symmetric piece which may evenly distribute the force applied to the harness from the leash portion around the dog's torso.

There may be another piece of material, such as leather, at a first end of the leash to protect the end of the leash from unraveling or being damaged.

The harness straps may be adjustable to fit a variety of dog sizes properly. This usability may allow the harness to continue providing a safe fit to the dogs as it grows. This may be preferable to traditional harnesses which may be minimally adjustable as the dog grows and often can incorrectly fit the dog, causing dangerous stress to their neck or arm joints, amongst other things.

An adjustable component, which may be made of leather and which may be rectangular, may have an even number of holes. The adjustable component may be located between the interconnection of the straps and the leash and the chest point, with the cord of the harness strung through the holes of the adjustable component. The cord may be strung such that the straps may increase and decrease in size approximately equally as the adjustable component moves. These holes may be large enough to allow the straps of the harness to move through them with ease when light pressure is applied. With the adjustable component, the harness may be able to be readily tightened and loosened around the dog. When the harness is loose, it may allow the dog to enter the harness easily. Once the dog is in the harness, the user may tighten the straps to secure the dog by adjusting the strap size to fit the dog's size and shape. Since the dog may exert force on the harness through forward movements and this component may tighten to rest on the dog's back, the harness may remain securely in place on the dog as it moves. One having skill in the art will recognize that multiple sizes of a harness, such as small, medium, and large, may be created.

Other potential uses of this harness may be guiding other animals, attaching carts to farm animals to transport goods, or securing loads to pulley systems, amongst other things.

Further features of this disclosure are detailed in subsequent sections and the attached drawings of this instant application.

### BRIEF DESCRIPTION OF THE DRAWINGS

The present description may be better understood from the following detailed description read in light of the appended drawings, wherein:

FIG. 1 illustrates a top view of a harness, according to one implementation.

FIG. 2 illustrates an adjustable component of the harness, according to one implementation.

FIG. 3 illustrates a harness, according to one implementation.

FIG. 4 illustrates how a harness may fit on the front of a dog, according to one implementation.

FIG. 5 illustrates how a harness may fit on the back of a dog, according to one implementation.

### DETAILED DESCRIPTION

A more particular description of certain implementations of a Harness may be had by references to the implementations shown in the drawings that form a part of this specification, in which like numerals represent like objects.

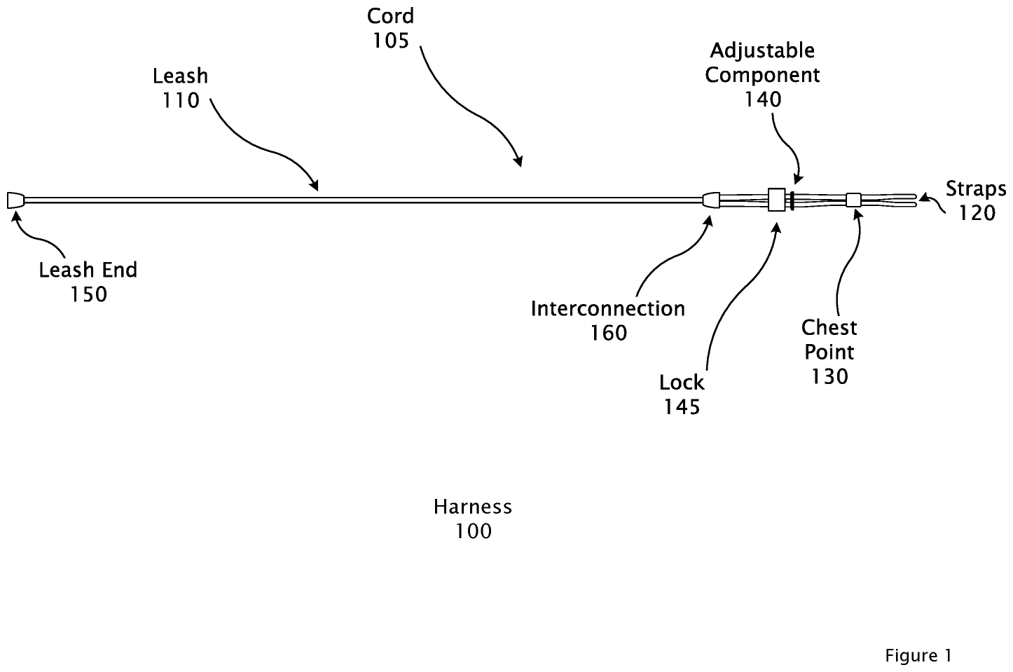

FIG. 1 illustrates a top view of Harness 100, according to one implementation. Harness 100 may be made of Cord 105, such as a rope, which may be configured so that part of it may form two straps which may go around front legs of a dog and another part forms a leash. Leash End 150 may be of a material that may wrap around an end portion of Leash 110 to protect the cord, which may prevent unraveling and offer additional durability. Interconnection 160 may be a piece of material that fixes one end of the cord while also allowing another portion of the cord to slip, which may allow resizing the straps by providing an easy way to adjust how much of the cord forms Straps 120 and how much of the cord forms Leash 110. Straps 120 may connect at Chest Point 130, which may rest on a dog's chest to provide comfort and minimize strain on the dog's armpits from Straps 120. Adjustable Component 140 may then be used to adjust the size of the harness to allow placing the harness on the dog easily, and then adjust Harness 100 to fit the dog to prevent the dog from easily slipping out of the harness. Lock 145 may slide along Cord 105, which may allow or prevent Cord 105 from moving through Adjustable Component 140 easily.

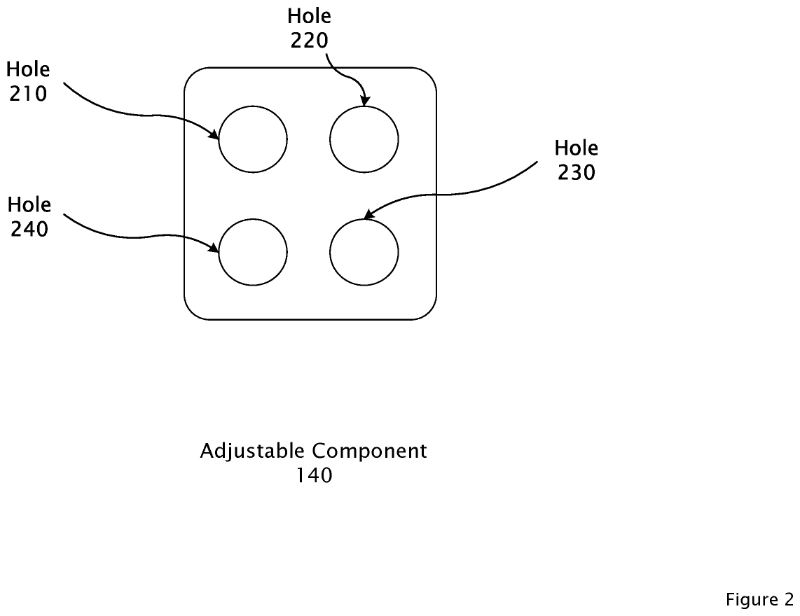

FIG. 2 illustrates the design of Adjustable Component 140 of a Harness 100, according to one implementation. There may be Holes 210, 220, 230, 240. Cord 105 may thread through Holes 210, 220, 230, 240 to allow easy adjustment of a size of Harness 100.

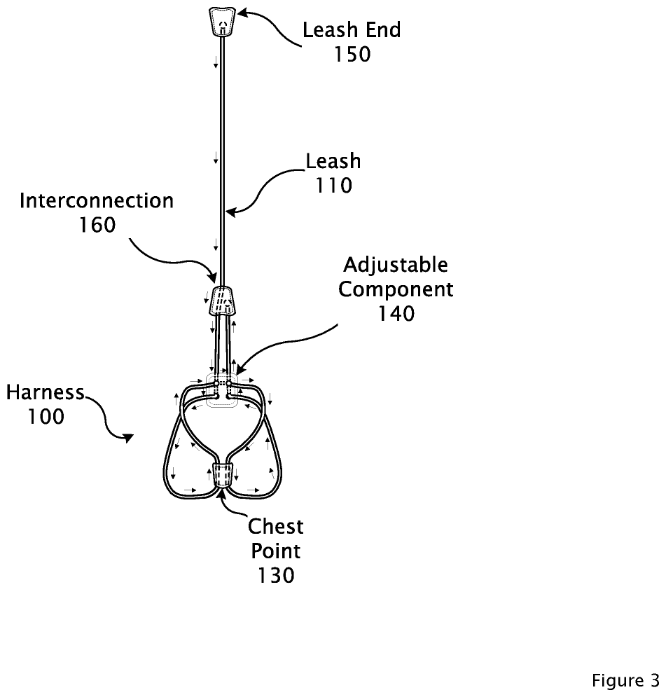

FIG. 3 illustrates a harness, according to one implementation. In this implementation, Harness 100 may comprise a leash portion and a harness portion that is made from Cord 105. In this example, Cord 105 may run from Leash End 150, a hole in Interconnection 160, and through Hole 210. From there, Cord 105 may form a Strap 120 to go behind and under the animal's front leg and through a first opening in Chest Point 130. It may then form another Strap 120 that passes over the animal's back and through Hole 240 ten through Hole 230. It may then go back through a second opening in Chest Point 130, behind and under the other front leg of the animal, through Hole 220, and to a second opening in Interconnection 160, where it may terminate and secure in place.

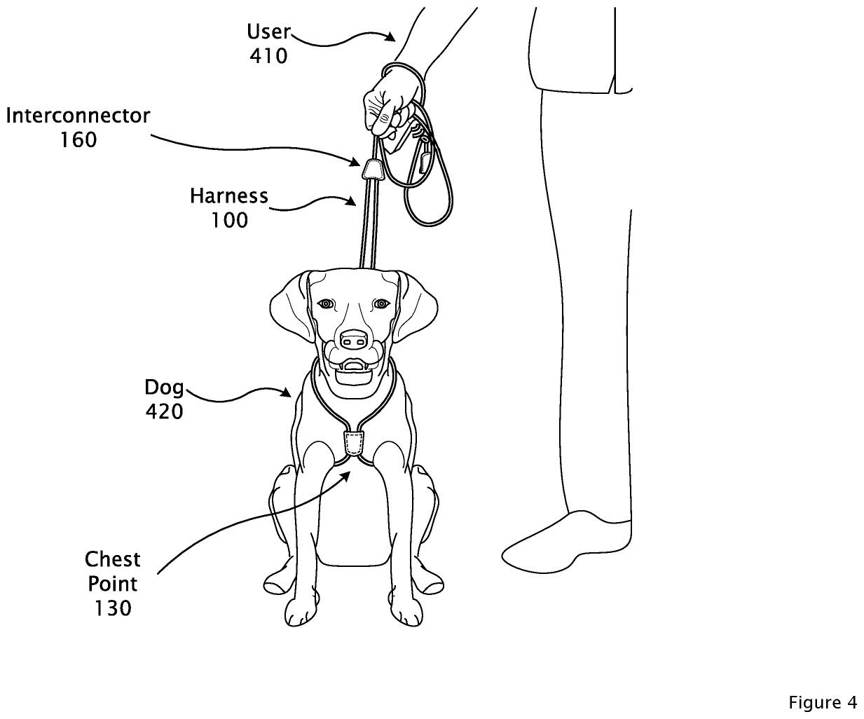

FIG. 4 illustrates how Harness 100 may fit on the front of Dog 420, according to one implementation. User 410 may hold onto the leash portion of Harness 100 to control Dog 420. Dog 420 may be of any size. Harness 100 may be designed in multiple sizes, which may include small, medium, and large. Harness 100 may be chosen to appropriately fit Dog 420 and offer a reasonably proportioned leash for User 410.

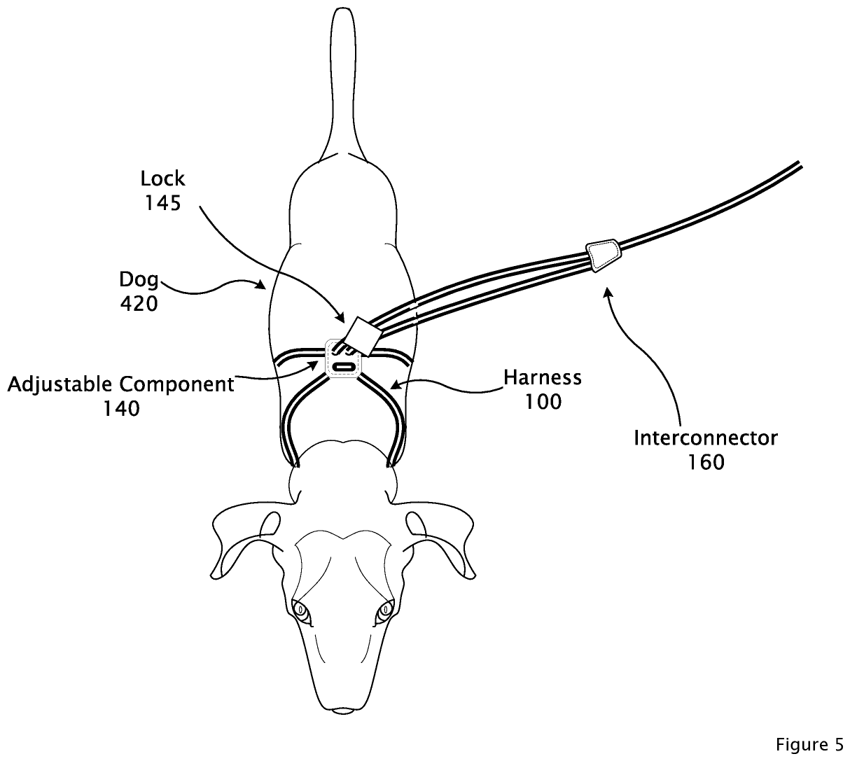

FIG. 5 illustrates how Harness 100 may fit on the back of Dog 420, according to one implementation. Dog 420 may be of any size. Harness 100 may be designed in multiple sizes, which may include small, medium, and large. Harness 100 may be chosen to appropriately fit Dog 420 and offer a reasonably proportioned leash for a user. Harness 100 may be properly adjusted to sit on the back of Dog 420 by using Adjustable Component 140 to adjust the fit.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data may provide a complete description of the manufacture and use of the invention. Since many embodiments of the invention can be made without departing from the spirit and scope of the invention, the invention resides in the claims hereinafter appended.

1. A harness, comprising:
a cord; the cord passing through an adjustable component, providing a leash portion and a straps portion, the straps portion operable to pass under front legs of a pet, securing the pet.

2. The harness of claim 1 wherein the adjustable component is made of leather and comprises four holes sized to allow the cord to pass through the four holes snugly.

3. The harness of claim 1 wherein the cord is made of rope.
